(19) United States
(12) Patent Application Publication
(10) Pub. No.: US 2006/0268846 A1
(43) Pub. Date: Nov. 30, 2006

(54) Server apparatus

(76) Inventors: Koji Shima, Sagamihara-shi (JP); Shigeru Fukazawa, Hachioji-shi (JP); Yasumasa Sasaki, Tachikawa-shi (JP); Fumikazu Matsukawa, Ome-shi (JP)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/444,545

(22) Filed: May 31, 2006

(30) Foreign Application Priority Data
May 31, 2005 (JP) 2005-160662

(51) Int. Cl. H04L 12/66

(52) U.S. Cl. 370/352

(57) ABSTRACT

According to one embodiment, a server apparatus includes a memory which stores information indicating a presence or absence of setting of a mode to omit the node IDs and stores the node IDs at every telephone exchange apparatus, and a controller which refers the information indicating the presence or absence corresponding to telephone exchange apparatuses at request origins when connection requests are generated, and connects data terminals corresponding to each of the plurality of the telephone terminals to be connected, based on the terminal IDs included in the call information and the node IDs stored in the memory, when the information indicates presence.

### CROSS-REFERENCE TO RELATED APPLICATIONS

This application is based upon and claims the benefit of priority from Japanese Patent Application No. 2005-160662, filed May 31, 2005, the entire contents of which are incorporated herein by reference.

### BACKGROUND

1. Field

One embodiment of the invention relates to a server apparatus of a visual communication system in which the server apparatus is connected to a plurality of telephone exchange apparatuses, being mutually connected through dedicated lines, via a communication channel and which can deal with a video signal and computer data, etc., in addition to a sound signal.

2. Description of the Related Art

In recent years, for instance, in an enterprise having a plurality of branches and sale offices, multinode systems, in which telephone exchange apparatuses, such as private branch exchanges (PBXs) or key telephone main apparatuses at each branch or sales office, respectively, to connect among these telephone exchange apparatuses via dedicated lines, have been widely used. Such types of systems can perform inter-extension communications and trunk line origination and termination of calls at every telephone exchange apparatus and also can perform extension communications among different telephone exchange apparatuses and trunk line origination and termination of calls via different telephone exchange apparatuses.

Recently, a system which connects a server to which data terminals such as television telephone terminals and personal computers are connected via transmission channel to a telephone exchange apparatus and which associates a sound communication system using the telephone exchange apparatus with a data communication system using the server has been proposed (e.g., Jpn. Pat, Appln. KOKAI Publication No. 8-321889).

Meanwhile, a system to cooperate with the data communication system using the server is strongly urged to be applied to the aforementioned multinode system. And furthermore, a service to construct a television conference, etc., by linking data communication connections among data terminals with call conditions of telephone terminals has been strongly desired. A parallel type system of the telephone exchange apparatus and the server given above; however, starts sessions among data communication terminals by linking with the call conditions of the telephone terminals to share data among the data terminals. And an application of a server to the above-mentioned multinode system or an additional service such as television conference has been in examination states and has not been achieved yet.

By the way, the linkage between the sound communication system by the multinode system and the data communication system using the server requires examinations for the following countermeasures.

That is, the multinode system usually makes connections using call IDs ‘3030000’ and ‘4040001’ if extension terminals usually to be connected have ‘node ID=30, DN=30000’ and ‘node ID=40, DN=40001’ when extension communications among different telephone exchange apparatuses are performed. However, overlap code setting to omit ‘node IDs’ in call IDs are performed sometimes so as to make easily display call IDs of partner terminals displayed on displays of the extension terminals, to reduce information qualities transmitting on the dedicated lines and to decrease burdens on dial operations.

In this case, it is presumed that a user of an extension terminal of a call ID ‘3030000’ dials ‘4040001’ in order to communicate to an extension terminal of a call ID ‘4040001’. A telephone exchange apparatus of a node ID ‘30’ then deletes a head ‘30’ because the head ‘30’ of a call ID ‘3030000’ of a caller in a communication establishment request signal coincides with its own node ID ‘30’, and transfers the request signal including ‘30000’ to the telephone exchange apparatus of node ID ‘40’ to call the extension terminal of DN ‘40001’ by the telephone exchange apparatus of the node ID ‘40’.

The setting of the overlap codes; however, is not reflected to the server, therefore, the extension terminal to be connected cannot be specified by the server. And connections among the data terminals are not established based on the call information event notified from the telephone exchange apparatus.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary schematic configuration diagram showing a visual communication system (VCS) regarding a first embodiment of the present invention;

FIG. 2 is an exemplary block diagram showing a functional configuration of a VCS server in the first embodiment of the present invention;

FIG. 3 is an exemplary view showing an example of a stored content in a connection information management table shown in FIG. 2;

FIG. 4 is an exemplary view showing an example of a stored content in a setting information management table shown in FIG. 2;

FIG. 5 is an exemplary view showing an example of an extension terminal-data terminal associating table shown in FIG. 2;

FIG. 6 is an exemplary view showing an example of a session information management table shown in FIG. 2;

FIG. 7 is an exemplary schematic sequence view showing transmission and reception operations of information among extension terminals, main apparatuses, the VCS server and data terminals in executing visual communication control in the first embodiment of the present invention;

FIG. 8 is an exemplary flowchart showing a control procedure of the VCS server in executing the visual communication control in the first embodiment of the present invention; and

FIG. 9 is an exemplary block diagram showing a functional configuration of a VCS server regarding a second embodiment of the present invention.

### DETAILED DESCRIPTION

Various embodiments according to the invention will be described hereinafter with reference to the accompanying drawings. In general, according to one embodiment of the invention, a server apparatus which receives call information including terminal IDs and node IDs specifying a plurality of telephone terminals to perform call connections by a plurality of telephone exchange apparatuses executing exchange processing among a plurality of telephone terminals and being assigned node IDs with one another and which links data communication connections at data terminals associated with the plurality of the telephone terminals, respectively, with the call connections, the server apparatus comprising: a memory which stores information indicating a presence or absence of setting of a mode to omit the node IDs and stores the node IDs at every telephone exchange apparatus; and a controller which refers the information indicating the presence or absence corresponding to telephone exchange apparatuses at request origins, when connection requests are generated, and connects data terminals corresponding to each of the plurality of the telephone terminals to be connected, based on the terminal IDs included in the call information and the node IDs stored in the memory, when the information indicates presence.

### First Embodiment

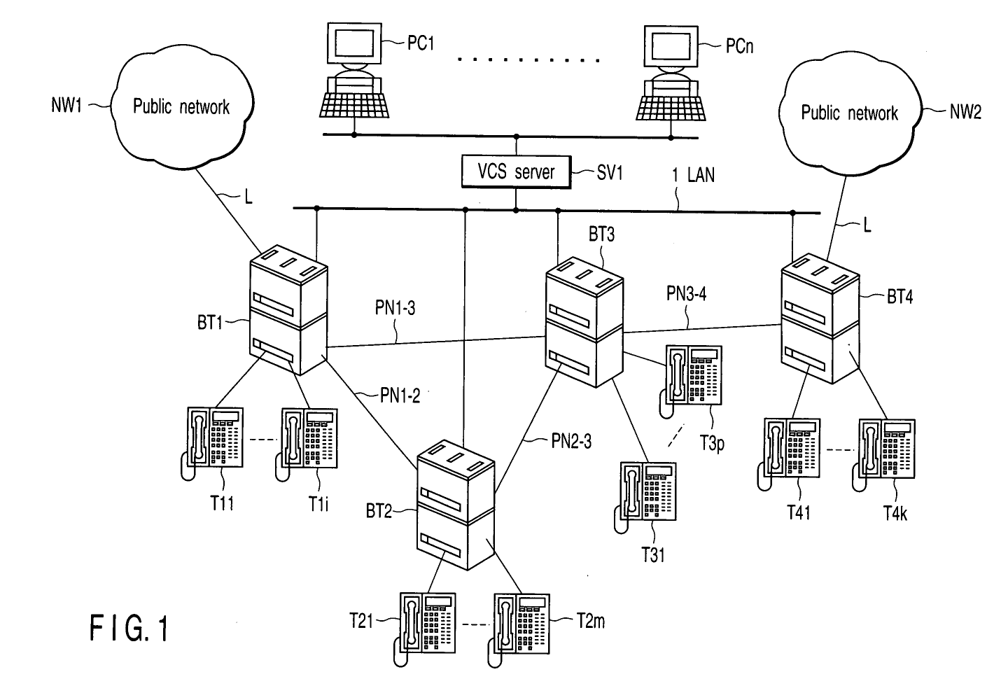

FIG. 1 is the exemplary schematic configuration diagram showing the visual communication system (VCS) regarding the first embodiment of the present invention.

The system, as shown in FIG. 1, has main apparatuses BT1-BT4 and connects these main apparatuses BT1-BT4 with one another via IP dedicated line PNs (PN1-2, PN1-3, PN2-3 and PN3-4). The main apparatuses BT1-BT4 house each extension terminal T11-T1i, T21-T2m, T31-T3p, and T41-T4k via extensions, respectively. The main apparatuses BT1 and BT4 are connected to public networks NW1 and NW2 via trunk lines L, respectively.

The main apparatuses BT1-BT4 each connect themselves to a local area network (LAN) 1. A VCS server SV1 is connected to the LAN 1. The VCS server SV1 houses a plurality of data terminals PC1-PCn. All of the data terminal PC1-PCn consist of general-purpose personal computers and operate in association with each extension terminal T11-T1i, T21-T2m, T31-T3p and T41-T4k, respectively.

The VCS server SV1 executes an additional function for each main apparatus BT1-BT4 and, for example, deals with media information on videos, etc.

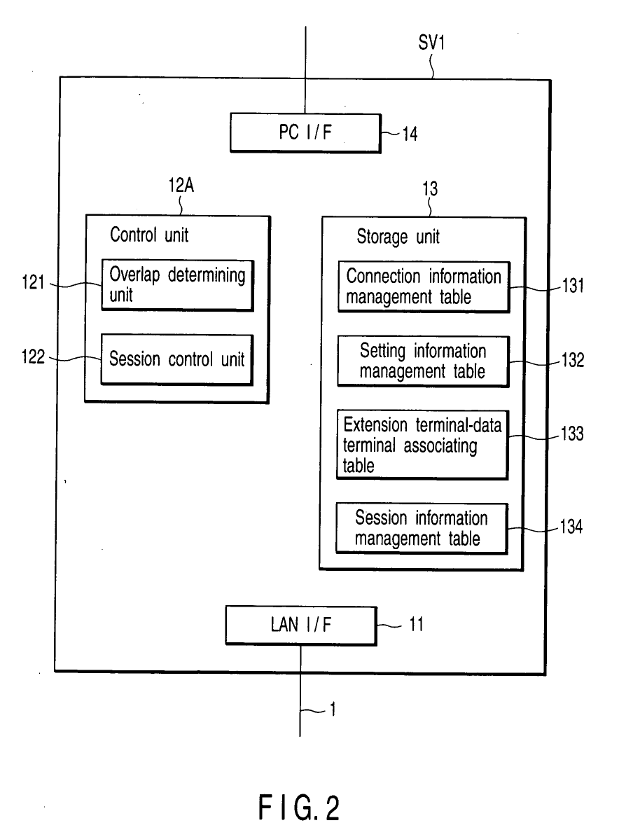

FIG. 2 is a block diagram showing a functional configuration of the VCS server SV1.

The VCS server SV1 comprises a LAN interface (I/F) unit 11, a control unit 12A, a storage unit 13 and a PC interface (I/F) unit 14. Among the units, the LAN I/F unit 11 conducts interface processing to the LAN 1.

The PC I/F unit 14 performs interface processing to the data terminals PC1-PCn.

The storage unit 13 stores routing information, etc., necessary for connection control to the control unit 12A. The storage unit 13 is further provided with a connection information management table 131, a setting information management table 132, an extension terminal-data terminal associating table 133 and a session information management table 134.

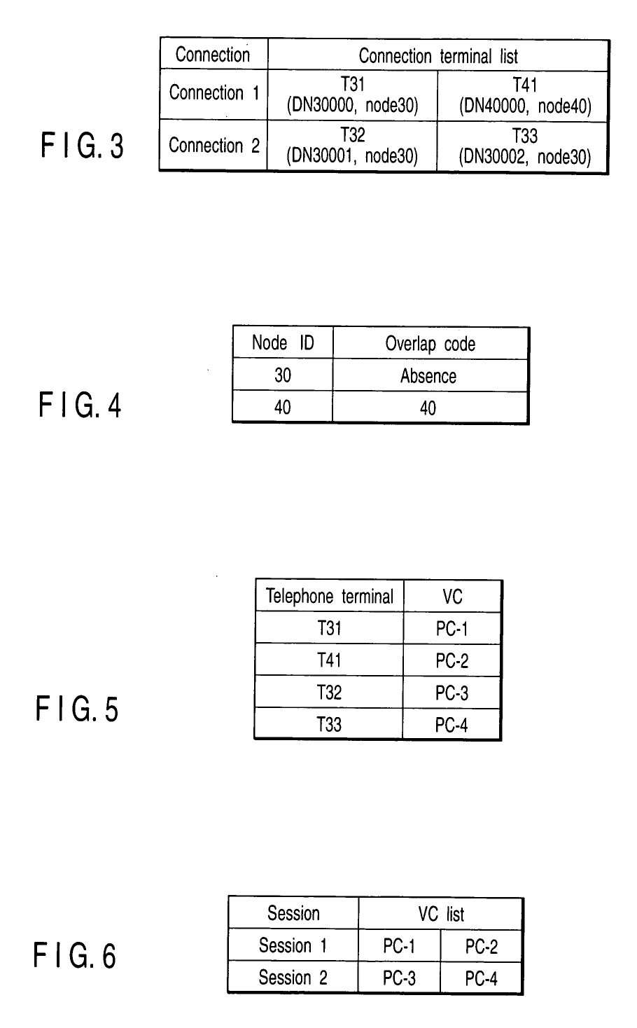

The connection information management table 131 stores information showing connection conditions among extension terminals T11-T1i, T21-T2m, T31-T3p and T41-T4k, as shown in FIG. 3. For instance, when the extension terminal T31 calls to the extension terminal T41 to make a communication therebetween, the main apparatus BT3 notifies the fact of the communication to the VCS server SV1 as a call information event. The VCS server SV1 determines that the terminals T31 and T41 have been in the communication by analyzing the event notified from the main apparatus BT3 to add and update the information on a connection 1 in the connection information management table 131.

The setting information management table 132 stores, as shown in FIG. 4, data indicating a correspondence relationship between node IDs and overlap codes. In this case, the setting information management table 132 stores beforehand setting information (setting of node IDs and corresponding overlap codes) in relation to all nodes present in the system.

The extension terminal-data terminal associating table 133 stores data indicating correspondence relationships between the extension terminals (telephone terminals) T11-T1i, T21-T2m, T31-T3p and T41-T4k and the data terminals PC1-PCn, as shown in FIG. 5. Here, the extension terminals T31, T32, T33 and T41 and the data terminals PC1-PC4 will be explained as representatives. When being connected to the VCS server SV1, the data terminals PC1-PCn notify extension numbers associating them with the VCS server SV1, and the VCS server SV1 updates the stored content in the extension terminal-data terminal associating table 133 in accordance with the notified information.

The session information management table 134 stores, as shown in FIG. 6, information indicating session conditions among data terminals PC1-PC4. When the condition of the connection 1 in the connection information management table 131 is updated, the VCS server SV1 reads out the fact that the extension terminal 31 is associated with the data terminal PC1 and the fact that the extension terminal T41 is associated with the data terminal PC2 based on the updated condition of the connection 1 to retrieve the session conditions of the data terminals PC1 and PC2 from the session information management table 134. For example, in the case of starting communications from now, since the data terminals PC1 and PC2 have not started a session, the VCS server SV1 controls so as to start the session therebetween. When the session between the data terminals PC1 and PC2 is established, the VCS server SV1 updates the stored content in the session information management table 134.

On the other hand, the control unit 12A has an overlap determining unit 121 and a session control unit 122 as new functions regarding the present invention in addition to a control function relating to condition management of the data terminals PC1-PCn and cooperative operations of data terminals PC1-PCn with extension terminals T11-T1i, T21-T2m, T31-T3p and T41-T4k.

The overlap determining unit 121 determines whether or not the main apparatus BT3 of the request origin has already been set the overlap codes based on the stored content in the setting information management table 132 when, for instance, the call information event relating to the communication between the extension terminals T31 and T41 from the main apparatus BT3.

In the case in which the overlap determining unit 121 determined that the overlap codes have been already set, the session control unit 122 reads out the corresponding node IDs from the setting information management table 132 and add it to the head of DN information as a terminal ID included in caller information in the call information event to make it caller information. The session control unit 122 then establishes sessions among corresponding data terminals PC1-PCn based on the caller information and recipient information in the call information event.

Next, operations of the VCS configured as given above will be described.

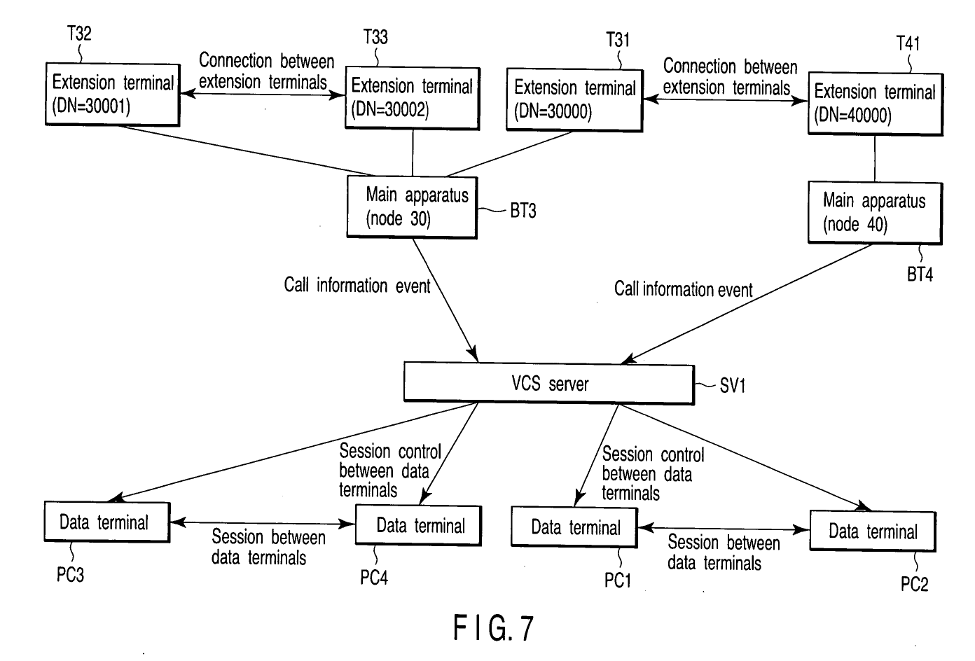

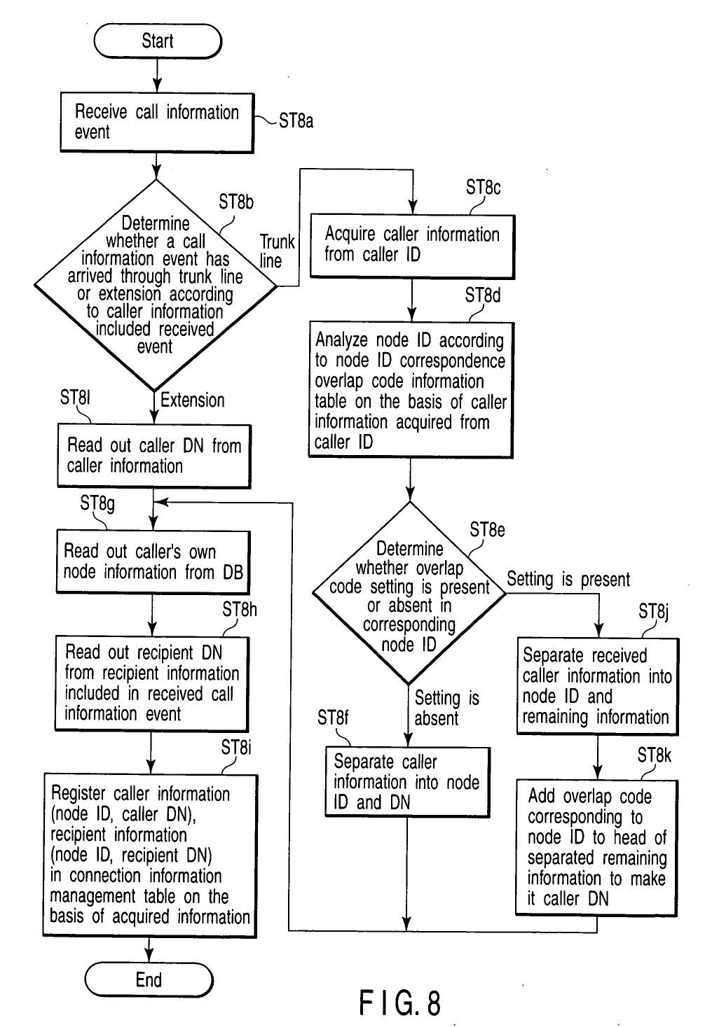

FIG. 7 is a schematic sequence view showing transmission and reception operations of information among extension terminals T31, T32, T33 and T41, the main apparatuses BT3 and BT4, the VCS server SV1 and the data terminals PC1-PC4 in executing visual communication control. FIG. 8 is a flowchart showing a control procedure of the VCS server SV1 in the executing of the visual communication control.

(Transmission Operation from Extension Terminal T31 to Extension Terminal T41)

In the extension terminal T31, it is supposed that a user conducts a dial operation of ‘4040000’ so as to make a communication with a user of the extension terminal T41. Then, the extension terminal T31 transmits its communication establishment request signal to the main apparatus BT3. When receiving the request signal, the main apparatus BT3 transfers the request signal to the main apparatus BT4 via the IP dedicated line PN3-4 and the main apparatus BT4 calls the extension terminal T41 of a called destination. When the extension terminal T41 responds to this calling, a communication link is established between the extension terminal T31 and the extension terminal T41.

Thus, the user of the extension terminal T31 becomes possible to make the communication with the user of the extension terminal T41.

The VCS server SV1 then receives the call information event from the main apparatus BT4 of a called side node (block ST8a) to determine whether the event has arrived from a trunk line or from an extension in accordance with caller information (device ID information) included in the received call information event (block ST8b).

Here, since the event has arrived from other node, the VCS server SV1 determines that the event has come through the trunk line to acquire caller information from a caller ID (block ST8c) and analyzes a node ID by referring to the stored content in the setting information management table 132 based on the caller information (in this case, ‘3030000’) acquired from the caller ID (block ST8d).

In this case, the node ID of the caller side node is ‘30’, so that the VCS server SV1 determines that the overlap code corresponding to the node ID is ‘Absence’, the VCS server SV1 makes a shift from a block ST8e to a block ST8f then separates the caller information into a node ID (in this case, ‘30’) and a DN (in this case, ‘30000’).

Next, the VCS server SV1 reads out its own node information (in this case, ‘40’) from the storage unit 13 (block ST8g) and reads out a recipient DN (in this case, ‘40000’) from recipient information (terminal ID information) included in the received call information event (block ST8h).

Subsequently, the VCS server SV1 registers caller information (node ID=30, caller DN=30000) and recipient information (node ID=40, recipient DN=40000), based on the acquired information given above (block ST8i).

After this, the VCS server SV1 is notified the fact of update of the stored content of the connection information management table 131, reads out the associations of the extension terminal T31 with the data terminal PC1 and the association of the extension terminal T41 with the data terminal PC2, based on the updated information of the connection 1. The VCS server SV1 then refers to the stored content in the session information management table 131 to retrieve the session condition between the data terminals PC1 and PC2.

As matters stand now, since a session has not started yet, the VCS server SV1 perform control in order to start the session between the data terminal PC1 and the data terminal PC2. When the session between the data terminals PC1 and PC2 has established, the VCS server SV1 updates the stored content in the session information management table 134.

At the disconnection of the communication link between the extension terminal T31 and the extension terminal T41, if the session between the data terminals PC1 and PC2 has been established, the VCS server SV1 instructs the data terminals PC1 and PC2 to terminate a visual communication therebetween. Thereby, the user becomes possible to automatically start a video communication only by conducting a usual telephone operation.

(Transmission Operation from Extension Terminal T41 to Extension Terminal T31)

In the extension terminal T41, it is assumed that the user performs a dial operation of ‘3030000’ so as to make a communication with the user of the extension terminal T31. The extension terminal T41 then transmits its communication establishment request signal to the main apparatus BT4. When receiving this request signal, the main apparatus BT4 transfers the request signal to the main apparatus BT3 via the IP dedicated line PN3-4, and the main apparatus BT3 calls the extension terminal T31 placed at the called destination. Then, the response of the extension terminal T31 for this calling forms a communication link between the extension terminal T41 and the extension terminal T31.

Thus, the user of the extension terminal T41 becomes possible to perform the communication with the user of the extension terminal T31.

The VCS server SV1 then receives the call information event from the main apparatus BT3 of the called side node to determine whether the event has arrived from a trunk line or from an extension in accordance with the caller information (device ID information) included in the received call information event.

Here, since the event has arrived from other node, the determination result from the VCS server SV1 shows the trunk line. And the VCS server SV1 acquires the caller information from a caller ID and refers to the stored content in the setting information management table 132 based on the caller information (in this case, ‘40000’) to analyze a node ID.

In such a case, the node ID of a caller side node is ‘40’, so that the VCS server SV 1 determines that the overlap code setting is ‘has been set’. And the SVC server SV1 makes a shift from the block ST8e to a block ST8j to separate the caller information into the node ID (in this case, ‘40’) and the remaining information (in this case, ‘000’).

Next, the VCS server SV1 reads out the overlap code (in this case, ‘40’) corresponding to the node ID from the setting information management table 132 and adds it to the head of the separated remaining information (in this case ‘000’) to make it a caller DN (block ST8k).

Next to this, the VCS server SV1 reads out own node information (in this case, ‘30’) from the storage unit 13 and reads out a recipient DN (in this case, ‘30000’) from the recipient information (device ID information) included in the received call information event.

Subsequently, the VCS server SV1 registers caller information (node ID=40, caller DN=40000), recipient information (node ID=30, recipient DN=30000) in the connection information management table 131, based on the acquired information.

After this, the VCS server SV1 is notified the fact that the stored content in the connection information management table 131 has been updated and reads out the associations of the extension terminal T31 with the data terminal PC1 and of the extension terminal T41 with the data terminal PC2 based on the updated information on the connection 1. And the VCS server SV1 refers to the stored content in the session information management table 134 to retrieve the session condition between the data terminals PC1 and the data terminal PC2.

In the present circumstance, the session has not started yet, so that the VCS server SV1 controls the VCS in the first embodiment in order to start the session between the data terminals PC1 and PC2. The VCS server SV1 updates the stored content of the session information management table 134 after establishing the session between the data terminals PC1 and PC2.

(Extension Communication Operation between Extension Terminals T32 and T33)

It is presumed that, in the extension terminal T32, a user performs a dial operation of ‘30002’ so as to make a communication with a user of the extension terminal T33. Thereby, the extension terminal T32 transmits its communication establishment request signal to the main apparatus BT3. When receiving the request signal, the main apparatus BT3 calls the extension terminal T33 of a called destination. Then, if the extension terminal T33 responds to this calling, a communication link between the extension terminal T32 and the extension terminal T33 is established.

Thus, the user of the extension terminal T32 becomes possible to perform a communication with the user of the extension terminal T33.

The VCS server SV1 then receives a call information event from the main apparatus BT3 of a called side node to determine whether the event has entered from a trunk line or from an extension line according to caller information (device ID information) included in the received call information event.

In this case, the event has arrived from its own node, so that the determination result shows the trunk line, the VCS server SV1 reads out a caller DN (in this case, ‘30001’) from the caller information (device ID information) (block ST81).

After this, the VCS server SV1 executes processing from the block ST8g to the block ST8j.

In the aforementioned first embodiment as described above, the VCS server Sv1 has the setting information management table 132 with setting information indicating the presence or absence of the overlap code setting stored therein, by associating the setting information with the node IDs of each main apparatus BT1-BT4. The VCS server SV1 furthermore determines whether the overlap setting has already done or not by using the setting information relating to the main apparatuses BT1-BT4 stored and managed in and by the setting information management table 132.

Accordingly, the VCS can coordinate the extension terminals T31 and T41 with the data terminals PC1 and PC2 corresponding with each other by performing appropriate visual communication control in a simple procedure regardless of presence or absence of overlap code setting at each main apparatus BT1-BT4.

In the first embodiment, the VCS determines whether the determination of the presence or absence of the overlap code setting is needed or not by using the caller information (device ID information) included in the call information events from the main apparatuses BT1-BT4 of the request origin prior to determining processing of the presence or absence of the overlap code setting. So that the VCS can conduct appropriate visual communication control at every extension terminal T11-T1i, T21-T2m, T31-T3p and T41-T4k to be connected to the main apparatuses BT1-BT4, respectively.

### Second Embodiment

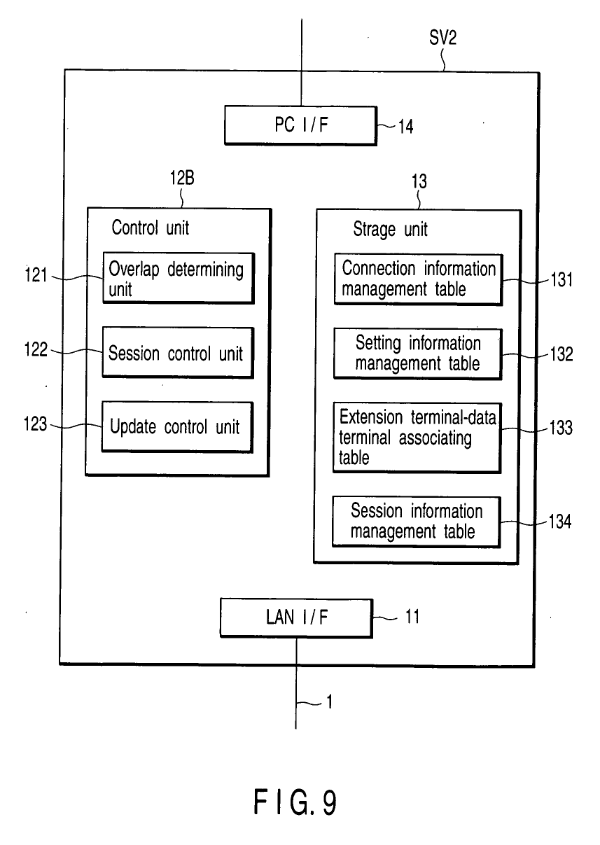

FIG. 9 the block diagram showing the functional configuration of the VCS server SV2 regarding the second embodiment of the present invention. In FIG. 9, the same functions as those of FIG. 2 are put the same symbols and the detail description thereof will be omitted.

That is to say, a control unit 12b further has an update control unit 123. The update control unit 123 acquires overlap code information corresponded to node IDs from each main apparatus BT1-BT4 with time intervals preset in accordance with a simple network management protocol (SNMP) to update the stored content in the setting information management table 132 to the acquired overlap code information corresponded to the node IDs.

The second embodiment configured as mentioned above can automatically and consistently update the stored content in the setting information management table 132 to the latest information without having to update it manually by the user.

### Other Embodiments

The present invention is not limited to each above-described embodiment. For instance, in the first and second embodiments, having described a method for storing the overlap code information corresponded to the node IDs in the storage unit of the VCS server beforehand by performing maintenance setting and a method for acquiring the overlap code information corresponded to the node IDs from each main apparatus periodically; however, the present invention is not limited to these methods, and if the VCS server is connected to a communication network, the manual registration from a maintenance terminal placed on the communication network is a possible approach.

Having described the example of connections among each main apparatus with the IP dedicated lines in the first embodiment; however, the present invention is not limited to the first embodiment, and the configuration in which each main apparatus is connected through a communication network other than the IP dedicated line is a possible approach.

As the rest, even a configuration and a type of the VCS server, types of the telephone exchange apparatuses (may be PBX not limited to main apparatus), types of the client terminals, storage contents of a variety of tables, authentication control methods, or the like can be implemented in a variety of modifications without departing from the sprit or scope of the present invention.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A server apparatus which receives call information including terminal IDs and node IDs specifying a plurality of telephone terminals to perform call connections by a plurality of telephone exchange apparatuses executing exchange processing among a plurality of telephone terminals and being assigned node IDs with one another and which links data communication connections at data terminals associated with the plurality of the telephone terminals, respectively, with the call connections, the server apparatus comprising:
a memory which stores information indicating a presence or absence of setting of a mode to omit the node IDs and stores the node IDs at every telephone exchange apparatus; and
a controller which refers the information indicating the presence or absence corresponding to telephone exchange apparatuses at request origins, when connection requests are generated, and connects data terminals corresponding to each of the plurality of the telephone terminals to be connected, based on the terminal IDs included in the call information and the node IDs stored in the memory, when the information indicates presence.

2. The server apparatus according to claim 1, when trunk line information, indicating the fact that one of the plurality of the telephone terminals to be connected, is added to the call information, wherein
the controller refers the information indicating the presence or absence corresponding to the telephone exchange apparatuses at the request origins from the memory based on the trunk line information.

3. The server apparatus according to claim 1, when extension information, indicating the fact that a plurality of telephone terminals to be connected are connected to extensions of the telephone exchange apparatuses at the request origins with one another, is added to the call information, wherein
the controller connects among data terminals corresponding to each of the plurality of the telephone terminals to be connected, respectively, based on the extension information and the terminal IDs acquired at acquiring the call information.

4. The server apparatus according to claim 1, further comprising:
an update device to acquire the information indicating the presence or absence of the setting of the mode to omit the node IDs from the telephone exchange apparatuses with prescribed time intervals to update stored content in the memory.
